(19) United States
(12) Patent Application Publication
(10) Pub. No.: US 2003/0076956 A1
(43) Pub. Date: Apr. 24, 2003

(54) Software implementation of cellular automata based random number generators

(76) Inventors: J. Barry Shackleford, Portola Valley, CA (US); Motoo Tanaka, Pleasanton, CA (US)

Correspondence Address: HEWLETT-PACKARD COMPANY, Intellectual Property Administration, P.O. Box 272400, Fort Collins, CO, 80527-2400, US

(21) Appl. No.: 09/977,978

(22) Filed: Oct. 17, 2001

(51) Int. Cl. H04L 9/00

(52) U.S. Cl. 380/263

(57) ABSTRACT

System and method to emulate cellular automata based random number generators (CA-based RNGs) in software are presented. Also, system and method to automatically generate software emulators of CA-based RNG are presented. A CA-based RNG is where an output of each cell of the CA at time t is dependent on inputs from any cells of the CA (including perhaps itself) at time t−1. The simulation software are high performing due to parallel simulation of multiple cells of the CA rather than emulating behaviors of cells individually and then combining the results. The simulation software may also include parallel site spacing capabilities.

### RELATED APPLICATIONS

The following applications of the common assignee, which are hereby incorporated by reference, may contain some common disclosure and may relate to the present invention:

U.S. patent application Ser. No. __/___,___, entitled “RANDOM NUMBER GENERATORS IMPLEMENTED WITH CELLULAR AUTOMATA” (Attorney Docket No. 10017475-1); and

U.S. patent application Ser. No. __/___,___, entitled “TRUTH TABLE CANDIDATE REDUCTION METHOD FOR CELLULAR AUTOMATA BASED RANDOM NUMBER GENERATORS” (Attorney Docket No. 100110346-1).

### FIELD OF THE INVENTION

This invention relates generally to random number generation. More specifically, this invention relates to software implementation of cellular automata based random number generators (CA-based RNG) and system and method to generate CA-based RNG software emulators.

### BACKGROUND OF THE INVENTION

Since the inception of computers, random numbers have played important roles in areas such as Monte Carlo simulations, probabilistic computing methods (simulated annealing, genetic algorithms, neural networks, and the like), computer-based gaming, and very large scale integration (VLSI) chip-testing. The bulk of the investigation into random (more properly, pseudo-random) number generation methods has been centered around arithmetic algorithms. This is because the prevalent computing medium has been the general purpose, arithmetic computer. In hardware, designers have long relied on feedback shift registers to generate random numbers.

In software, arithmetic methods such as linear congruential generator method has been used. However, arithmetic methods are subject lattice defects. A lattice defect is where groups of successive numbers, taken to define a point in a n-space where n is the group size, tend to form planes rather than being uniformly distributed in the n-space. Following example will clarify the concept of the lattice defect.

Assume that a sequence of numbers is generated using the linear congruential generator method. Also assume that the sequence is grouped such that the 1^{st} number, 4^{th}, 7^{th}, etc. are in a first group (x-group); 2^{nd}, 5^{th}, 8^{th}, and so on are in a second group (y-group); and every 3^{rd}, 6^{th}, 9^{th}, and so on are in a third group (z-group). Then on an three-dimensional Cartesian coordinate system, the positions defined by the groups of numbers are plotted. For example, point p1 is defined by the coordinates (x1, y1, z1)=(1^{st} number, 2^{nd} number, 3^{rd} number), point p2 is defined by=(x2, y2, z2)=(4^{th}, 5^{th}, 6^{th}), and so on. When the positions are plotted, distinct planes, i.e., lattice defects, are generated by the plotted points instead of being uniform throughout the 3-dimensional space.

In hardware, random numbers (more correctly pseudo-random numbers) have been generated from linear shift feedback registers. However, stringent random number tests, such as DIEHARD suite of tests, have shown that such random number generators may be deficient.

Random numbers may also be generated in hardware using cellular automata based random number generators (CA-based RNGs). The CA-based RNGs may be implemented using field programmable gate arrays (FPGAs) for example. Some of these have been shown to pass the DIEHARD suite of tests.

In 1986, Wolfram (S. Wolfram, “Random sequence generation by cellular automata,” Advances in Applied Mathematics, vol. 7, pp. 123-169, June 1986) described a random sequence generation by a simple one-dimensional (1-d) cellular automata with a neighborhood size of three. The work focused on the properties of a particular CA-based RNG dubbed “CA30,” so named due to the decimal value of its truth table. Statistical tests indicated that the CA30 was a superior random number generator to the ones based on linear feedback shift registers. Wolfram suggested that efficient hardware implementation of the CA30 should be possible.

Hortensius et al. (P. D. Hortensius, R. D. McLeod, and H. C. Card, “Parallel number generation for VLSI systems using cellular automata,” IEEE Transactions on Computers, vol. 38, no. 10, pp. 1466-1473, October 1989) described the use of CA30 as a random number generator in an Ising computer. They also described using combinations of CAs (CA90 and CA150), which generated even better random numbers than the CA30. They further indicated that time and site spacing may improve statistical quality of random numbers generated by the CA. Time spacing is where the RNG is advanced more than one step between random number samples and site spacing is where not every bit value generated is used.

Cellular automata (CA) may be thought of as a dynamic system discrete in both time and space. CA may be implemented as an array of cells with homogeneous functionality constrained to a regular lattice of some dimension. For example, in one-dimension, the lattice could be a string (open-ended) or a ring (close-ended), or in two-dimensions, the lattice could be a plane (open-ended) or a toroid (close-ended). Open-ended CAs have boundaries that are fixed and close-ended CAs have boundaries that are periodic.

A function of a CA cell may be represented as a truth table. FIG. 1A shows an exemplary truth table for a four-input CA cell. FIG. 1B shows an exemplary implementation of a cell of the CA. As shown, the cell i implicitly includes a one-bit register. In this instance, there are 16 possible conditions to which a cell may respond (the neighborhood size N is 4 corresponding to the number of inputs). The number of unique responses is ₂2^{N} or 65,536 when N=4. In other words, there can be 65,536 unique four-input machines for a given interconnection topology. The number of machines grows to over 4 billion with when the neighborhood size N grows to 5.

Referring back to FIG. 1A, a notation is provided to identify the CA implementing the above function. In essence, the output of the truth table is used as the identification in conjunction with the interconnection notation. As shown, the output of the truth table is converted to a number (from binary to base 16 to decimal). The CA represented by the truth table in FIG. 1A is denoted to be CA06990.

As indicated before, a CA may be made of multiple cells, and the inputs of one cell may connected to the output of other cells. There may even be a feedback contact meaning that one of the inputs of the cell is connected the output of the cell itself. Thus, to uniquely identify a CA, the interconnection topology information should also be provided in addition to it's truth table representation. FIG. 1C illustrates an exemplary notation, relative displacement notation, which indicates the interconnection topology information of cell i, i.e., how far away the connecting cells are relative to a given four-input cell i.

As an example, FIG. 1D illustrates a 64-cell one-dimensional ring automata network with a displacement of {−1, 0, 1, 2} from the perspective of cell 0. In this instance, each cell i is assumed to have the same displacement value. In other words, all cells of the CA have identical functions. In a one-dimensional ring CA network, each cell i has two adjacent neighbors, one on either side. Because the CA network is periodic, cell 63 is adjacent to the cell 0, and thus the displacement of i−1 from cell 0 lands on cell 63.

In a one-dimensional CA network, a relative displacement value {−1, 0, 1, 2} indicates that d₈ input of cell i is connected to the output of the cell i−1 (one cell to the left), the d₄ input is connected to the output of the cell i itself, the d₂ input to cell i+1, and the d₁ input to cell i+2. More specifically, from the perspective of cell 0, the inputs d₈, d₄, d₂, and d₁, are connected to the outputs of cell 63, itself, cell 1, and cell 2, respectively.

As discussed above, CA-based RNGs may be used to generate random numbers. The CA-based RNGs may also be emulated in software to minimize or eliminate the possibility of suffering from lattice defects. However, the software simulation usually suffers from performance problems. In addition, having software emulations behave like the actual hardware may be problematic since many software programming systems incorporate their own random number generators.

### SUMMARY OF THE INVENTION

In a first aspect of the present invention, a method to emulate a cellular automata based random number generator (CA-based RNG) in software may include determining emulation parameters for the CA-based RNG and initializing the software. The method may further include simulating behaviors of cells of the CA-based RNG in parallel. The simulation may include capability to automatically perform site spacing.

In a second aspect of the present invention, a method to generate a software code which emulates a CA-based RNG may include determining random number generation parameters and determining one or more programming language templates. The method may also include determining functional definition of the CA-based RNG. The method may further include determining routines including initialization routines, simulation routines, and simulation results output routines. The method may yet include outputting the generated code to various destinations.

In a third aspect of the present invention, a system for generating a software code to emulate a CA-based RNG may include a RNG-parameter-module determining RNG parameters and a language-template-module determining language templates. The system may also include a routines-generating-module generating routines for emulating the CA-based RNG. The generate simulation code may include capability to automatically perform site spacing.

### BRIEF DESCRIPTION OF THE DRAWINGS

Features of the present invention will become apparent to those skilled in the art from the following description with reference to the drawings, in which:

FIG. 1A illustrates an exemplary truth table for a four-input cellular automata (CA) cell and the naming notation for the cellular automata;

FIG. 1B illustrates an exemplary implementation of a cell of a CA;

FIG. 1C illustrates an exemplary notation, a relative displacement notation, which provides a connection information of a CA cell;

FIG. 1D illustrates an exemplary CA showing the relationship between the relative displacement notation and the interconnection topology;

FIG. 2 illustrates an exemplary method to emulate a CA-based RNG;

FIGS. 3A-3C collectively illustrate an exemplary software code with instructions to emulate a CA-based RNG;

FIG. 4 illustrates an exemplary method to generate a software code which emulates a CA-based RNG;

FIG. 5 illustrates an exemplary system which generates a software code to emulate a CA-based RNG; and

FIGS. 6A-6F collectively illustrate an exemplary software code which generates software code to emulate a CA-based RNG.

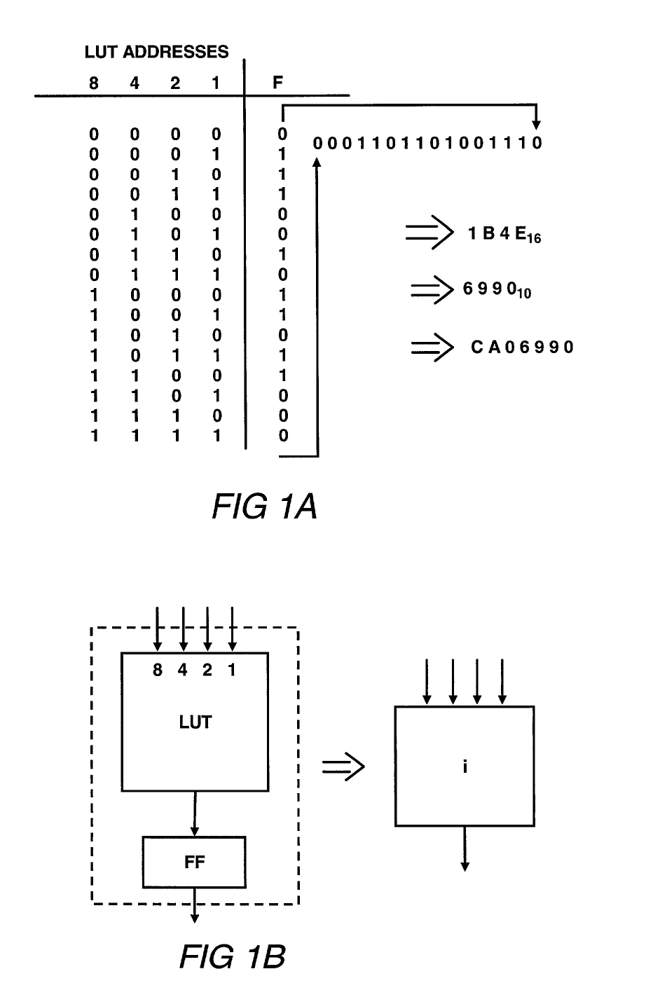

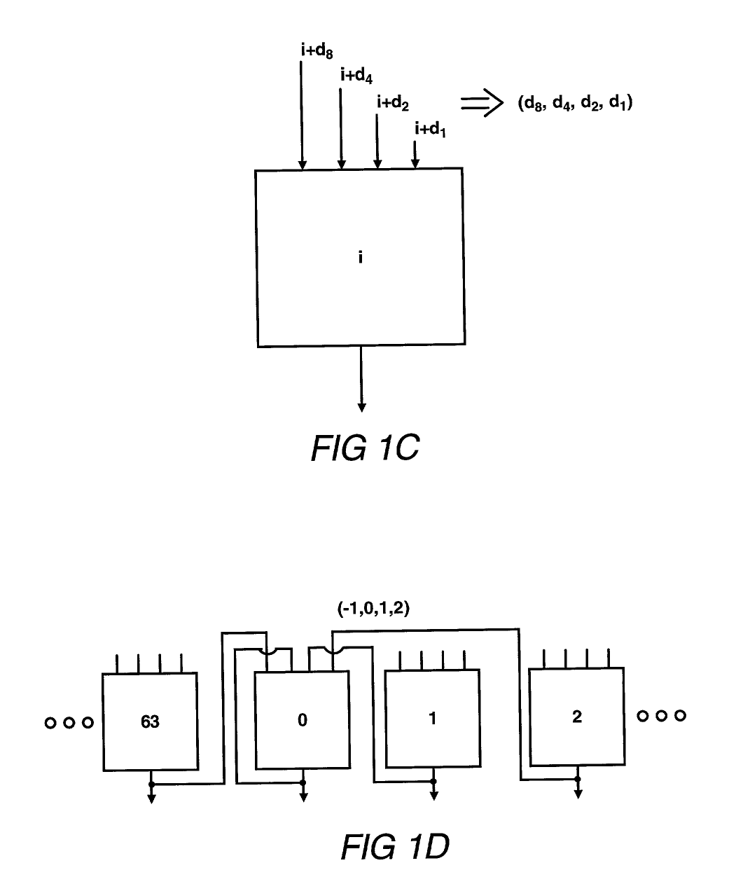

### DETAILED DESCRIPTION

For simplicity and illustrative purposes, the principles of the present invention are described by referring mainly to exemplary embodiments thereof. However, one of ordinary skill in the art would readily recognize that the same principles are equally applicable to many situations in which random numbers generators are simulated in software.

As discussed above, a CA-based RNG may be defined by its interconnection topology and by its truth table. For explanation purposes, software simulation of periodic (close-ended) CA-based RNGs composed of identical-function cells and identical interconnection topologies are described. In other words, all cells of the CA have identical truth tables and all cells are connected to other cells with equal displacement for each corresponding input. However, one of ordinary skill in the arts may easily extend the concept of the present invention to simulation of CA-based RNGs with non-identical-function cells and non-identical interconnection topologies.

In the following, software simulation of CA51510 with displacement values {−7, 0, 11, 17} is described. In other words, all cells of CA51510 {−7, 0, 11, 17} have identical functions as represented by the truth table in Table 1 below.

TABLE 1

| | | | | | | | | | | | | | | | | |
|---|---|---|---|---|---|---|---|---|---|---|---|---|---|---|---|---|
| d₈ | 1 | 1 | 1 | 1 | 1 | 1 | 1 | 1 | 0 | 0 | 0 | 0 | 0 | 0 | 0 | 0 |
| d₄ | 1 | 1 | 1 | 1 | 0 | 0 | 0 | 0 | 1 | 1 | 1 | 1 | 0 | 0 | 0 | 0 |
| d₂ | 1 | 1 | 0 | 0 | 1 | 1 | 0 | 0 | 1 | 1 | 0 | 0 | 1 | 1 | 0 | 0 |
| d₁ | 1 | 0 | 1 | 0 | 1 | 0 | 1 | 0 | 1 | 0 | 1 | 0 | 1 | 0 | 1 | 0 |
| F | 1 | 1 | 0 | 0 | 1 | 0 | 0 | 1 | 0 | 0 | 1 | 1 | 0 | 1 | 1 | 0 |

Generally, a lookup table with an n-bit address input, whose output is either 1 or 0, can be thought of as a Boolean logic function with each 1-output representing a Boolean n-cube. For example, we note that the CA51510 outputs a 1 in location 2 (d₈=0, d₄=0, d₂=1, and d₁=0). This may be represented by the following Boolean 4-cube expression (1):

˜d₈ & ˜d₄ & d₂ & ˜d₁ (1)

where “&” represents a logical AND function and “˜” represents a logical inversion operation. As expressed, the Boolean 4-cube may be referred to as a product term.

The aggregate of 1s in the lookup table may be represented as a sum-of-products logic equation. The sum-of-products logic equation may be readily expressed in conventional programming languages. Referring back to Table 1, the CA51510 outputs 1s in locations 1, 2, 4, 5, 8, 11, 14, and 15 as defined by the binary inputs d₈, d₄, d₂, and d₁. This may be expressed by the Boolean logic equation (2):

f=(d₈ & d₄ & d₂ & d₁)|(d₈ & d₄ & d₂ & ˜d₁)|(d₈ & ˜d₄ & d₂ & d₁)|(d₈ & ˜d₄ & ˜d₂ & ˜d₁)|(˜d₈ & d₄ & ˜d₂ & d₁)|(˜d₈ & d₄ & ˜d₂ &˜d₁)|(˜d₈ & d₄ & ˜d₂& ˜d₁)|(˜d₈ & ˜d₄ & d₂ & ˜d₁)|(˜d₈ & ˜d₄ & d₂ & d₁) (2)

where “|” represents the logical OR operation (the sum in the sum-of-products). Thus the truth table of the CA-based RNG may be represented in software by the sum-of-products equation. There is no particular need to minimize the logic equation manually because modern compilers readily perform such logic minimization.

To represent the connectivity (the interconnection topology) of each cell to other cells, multiple copies of the cellular automata (CA) state variable may be used with each copy rotated clockwise or counter clockwise in a manner to bring its bits into alignment with the reference cell i. Each state variable may be a computer word or words containing all bits of the cellular automata. For example, if the length of the CA-based RNG is 64 bits and the word length of the computer is 32, then two words may be used represent the CA state variable.

Using the above illustration with displacement values {−7, 0, 11, 17} and assuming clockwise numbering of the cells, state variable d₈ may be represented by the CA state variable rotated 7 cell in the clockwise direction, state variable d₄ need not be rotated, state variable d₂ my be rotated counter clockwise 11 cells, and d₁ may be rotated 17 cells also in the counter clockwise direction. Then the function represented by equation (2) may be computed in parallel using the full width of the computer arithmetic logic unit (ALU). Parallel computation enhances the performance of the simulation considerably.

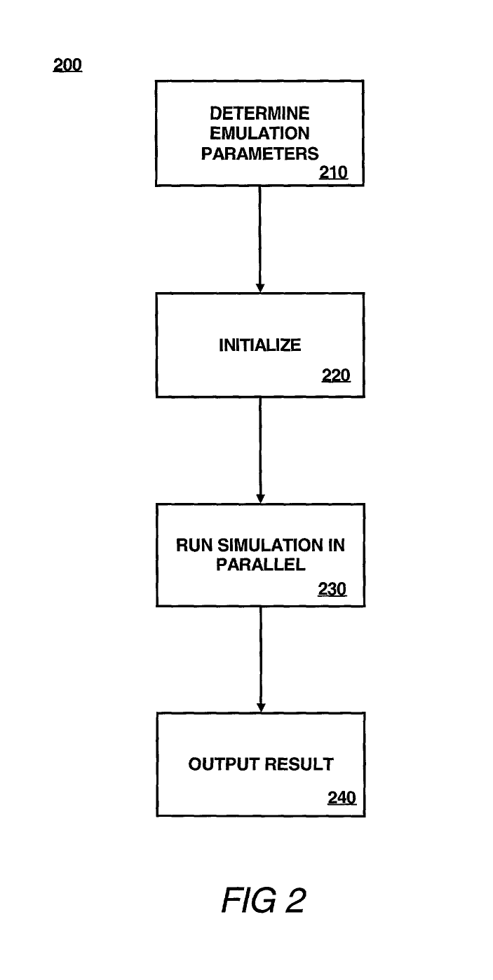

FIG. 2 illustrates an exemplary method 200 that a software emulator may perform to emulate a CA-based RNG. The method 200 may determine emulation parameters (step 210). Many ways exists to determine the emulation parameters. For example, the parameters may be directly received from a user, read from a file, received from a database, and the like. Examples of emulation parameters include seed, number of runs (corresponding to the amount of random numbers generated), output designation (file, display, data base), and the like. For any of the parameters not provided, default values may be specified automatically.

The method 200 may also initialize the software (step 220). The initialization may be based on parameters received (or default values if none received). The method 200 may continue with running the simulation (step 230). Note that the simulation step 230 simulates the behavior of the cells of the RNG in parallel. In other words, the behavior of the cellular automata is emulated. It is not the case where the behavior each cell is calculated individually, and the results combined.

It should be noted that the amount of parallelism depends on the particular computing system used in the simulation and the length of the random number to be simulated. This is because the state individual cells may be represented by a bit in a word of a computer. A typical computer architecture defines a word to be 32 bits long. In this instance, by using bit wise operations, a CA-based RNG of lengths up to 32 bits may be emulated in parallel in one set of operations. However, for an RNG of 64 bits, two sets of operations will be required. But even in this type of situation, performance is enhanced due to the amount of parallelism involved.

In addition, parallel site spacing capability may be included in the method 200. It has been noted above that site spacing improves the quality of the random numbers generated. For example, a 64-bit number may be represented by two 32-bit words. Instead of having the first and second word representing consecutive bits of the 64-bit number, the first word may represent the even bits and the second word may represent the odd bits. The operation to rotate the 64-bit number to the left and to the right may be be appropriately coded. With this structure, performing site spacing, for example to generate a 32-bit random number would be a simple matter of outputting the first or the second word, which represents the even bits or the odd bits, respectively. One of ordinary skill will realize that site spacing of other than 2 may be generated without departing from the scope of the invention.

The method 200 may also output the result of the simulation (step 240). The output may be directed to one or more target destinations. For example, the output may be directed to be displayed on a computer screen, used as inputs to another application, written to a file, sent to a remote destination, added to a database, and the like.

One of ordinary skill in the arts will realize that the steps of the method 200 need not be performed exactly in the order shown. It is contemplated that steps of the method 200 may be modified or deleted, or other steps may be added, and still be within the scope of the invention.

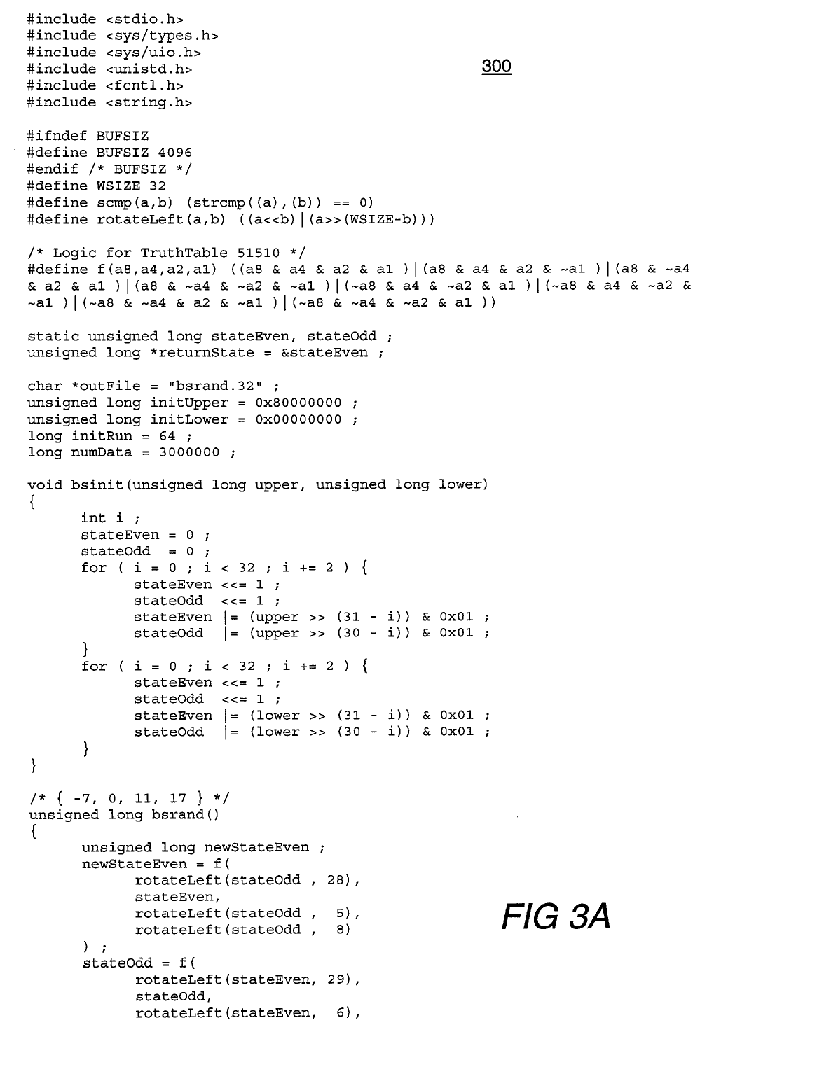

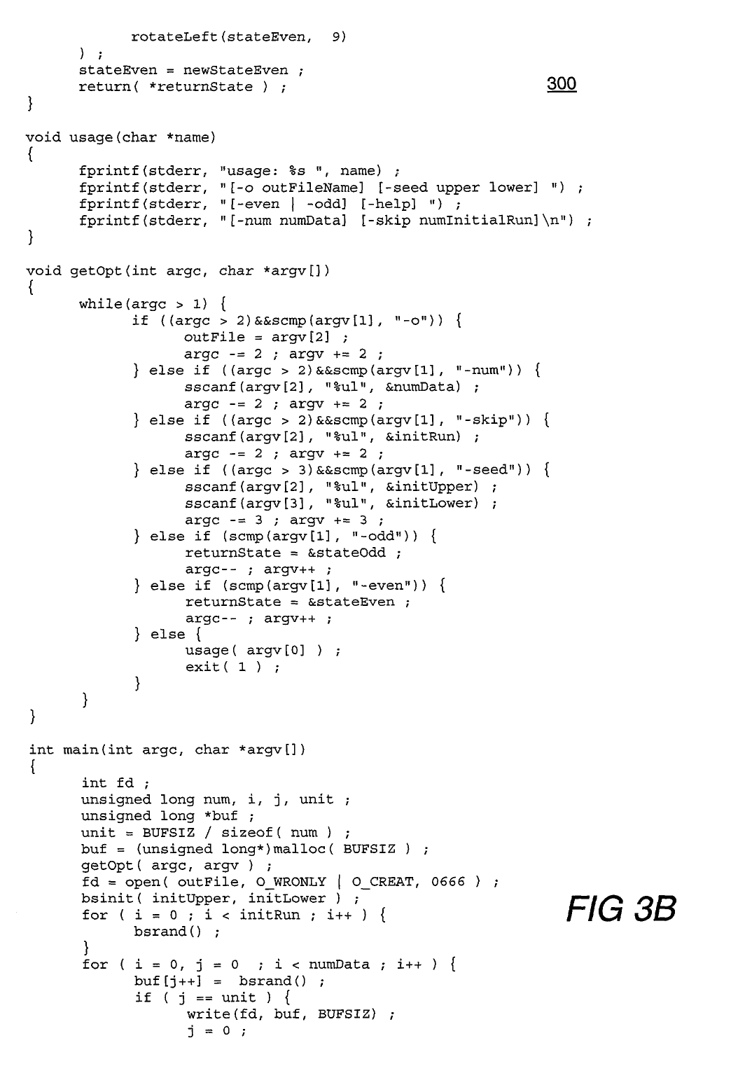

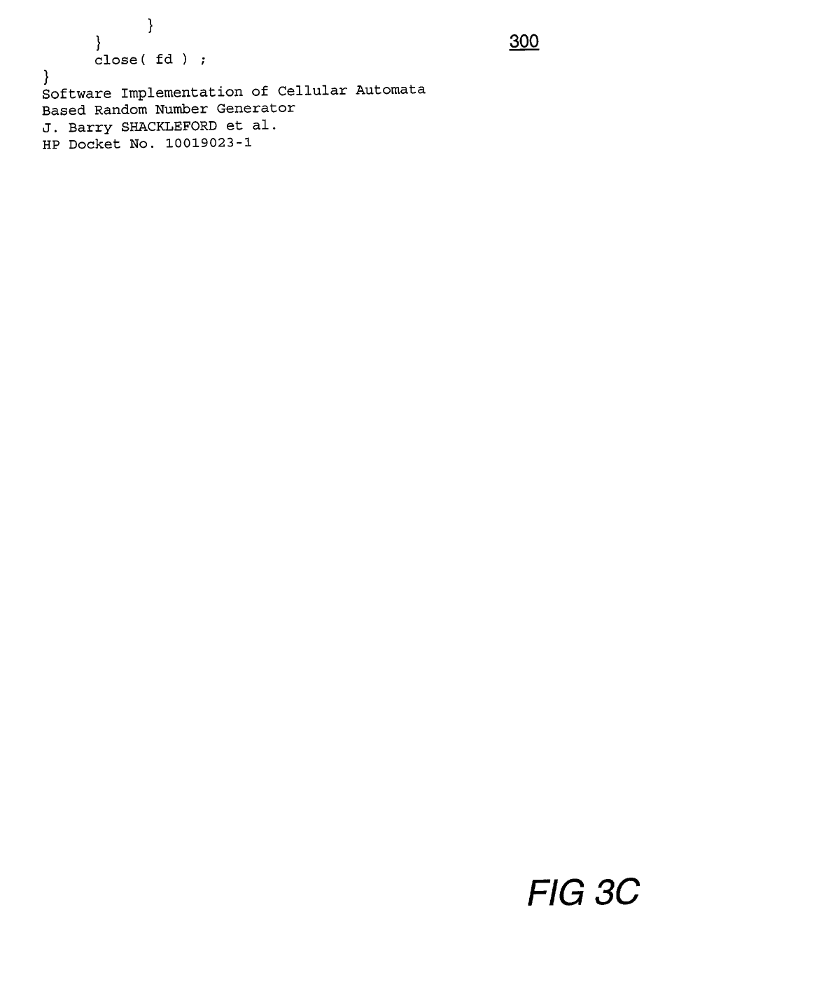

FIGS. 3A-3C collectively illustrate an exemplary software code 300 with instructions to emulate the CA51510 {−7, 0, 11, 17}. (displacement notations d₈, d₄, d₂, and d₁ have been replaced with address notations a8, a4, a2, and a1, respectively, in the program). Note that the code includes parallel simulation operations, i.e., simultaneous rotation of multiple bits of the state variables (rotateLeft( ) ). The code also includes parallel site spacing capability (stateEven and stateOdd state variables). Rotating the variables to the right may be accomplished by rotating to the left by appropriate amount due to the periodic nature of the CA-based RNG.

Note that determining the appropriate shift amounts to support displacements and site spacing are not trivial tasks and thus are prone to error. As will be seen below, automatic code generation alleviates these difficulties and thus helps to minimize errors from being generated.

The C programming language was used to generate the software code 300. However, one of ordinary skill in the arts will realize that other programming languages such as C++, Java, J++, Pascal, Fortran, Basic, and the like may be used without departing from the scope of the application.

The method 200 (shown in FIG. 2) and the example code (of FIG. 3) emulates a particular CA-based RNG. However, instead of coding each individual simulator manually, the software code may be automatically generated. In this way, significant amount of time may be saved. In addition, coding errors may be minimized or eliminated as noted above.

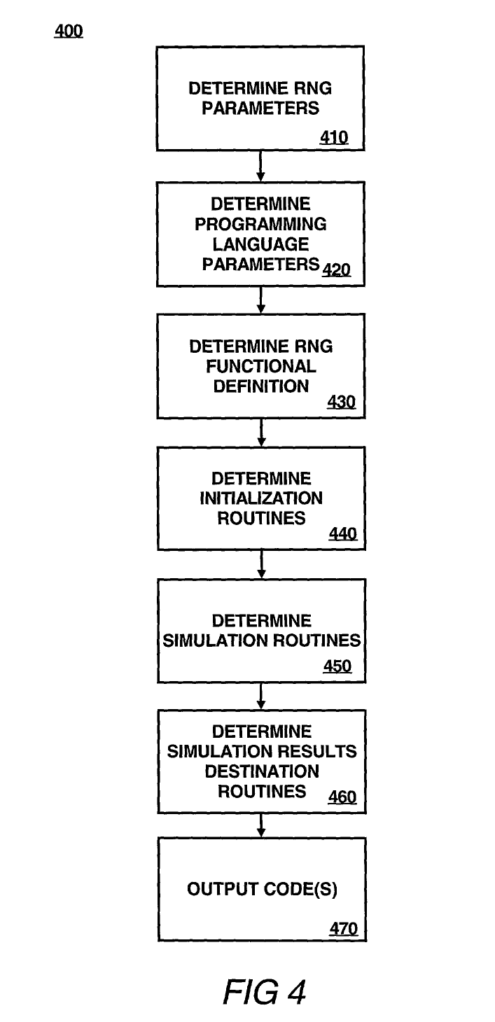

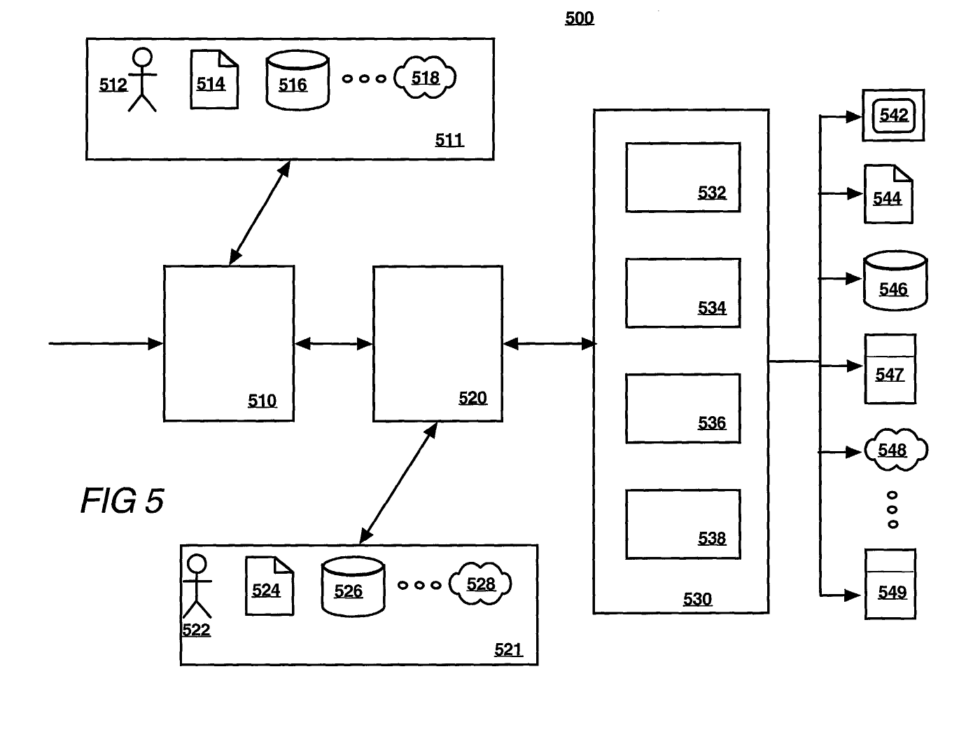

FIG. 4. illustrate an exemplary method 400 to generate a software code which emulates a cellular automata based random number generator. As shown in FIG. 4, the method 400 may determine the RNG parameters (step 410). Many ways exist to determine the RNG parameters. For example, the RNG parameters may be directly received from a user, read from a file, received from a database, and the like. Examples of RNG parameters may include the interconnection topology (cell connection information), the length of the desired CA-based RNG (length of the random number), CA function (truth table), desired output programming language or languages, code output destinations, site spacing specification, and the like. For any of the parameters not provided, default values may be specified.

The method 400 may also retrieve template(s) for the desired programming language or languages (step 420). For example, the RNG parameters may specify that C and Pascal code be generated. In this instance, templates for these computer languages may be retrieved. The language templates may be kept in a file, database, on a remote site retrievable over a network, and the like. If no template is specified, default language template or templates may be provided.

The method 400 may further determine a functional definition of the CA-based RNG (step 430). For example, given the truth table of the CA-based RNG, an equivalent sum-of-products Boolean logic equation may be generated. The method 400 may determine initialization routines (step 440) and simulation routines (step 450) as well. The simulation routines may include parallel simulation operations and site spacing capability. In addition, the method 400 may determine simulation results destination routines (460) so that the generated code has instructions to output the results of the simulation to desired storage(s) and display(s).

The routines that are determined may then be converted into software code in the desired programming languages and outputted. The generated code may be output to a file, to a display, to a database, to a compiler, to an interpreter, to a remote location over a network, and the like. This resulting code may be compiled for a target computing system or systems to simulate the CA-based RNG. The target computing system may also interpret the generated code as well.

FIG. 5 illustrates a block diagram of an exemplary system 500 which generates a software code to emulate a cellular automata based random number generator. As shown in FIG. 5, the system 500 may include a RNG-parameter-module 510. The types of RNG parameters has been discussed above and need not be discussed in detail here. The sources (511) for the parameters may be from any one or more of user(s) 512, parameter file(s) 514, parameter database(s) 516, remote parameter source(s) 518 (for example, networked computers, computers on a LAN, and the like), and the like. Again, if the source(s) (511) are not specified, then a default source or sources may be checked or default values for the parameters may be provided.

The system 500 may also include a language-template-module 520. The sources for the language templates (521) may be user(s) 522, template file(s) 524, template database(s) 526, remote template source(s) 528, and the like. The language-template-module 520 may also include built-in language template or templates. For example, the built-in template may be the C language. Thus, if no specific template is chosen, the module may retrieve a template from a default source or sources (such as the file 524) or use the built-in template(s).

The system 500 may further include a code-generating-module 530 generating the software code to emulate CA-based RNGs. The code-generating-module 530 may include a functional-definition-module 532 which generates Boolean logic equations equivalent to the truth table of the target CA-based RNG; an initialization-generation-module 534 which generates initialization routines for the target language or languages; a simulation-generation-module 536 which generates simulation routines (including parallel operations and site spacing capabilities); and an output-generation-module 538 which generates simulation results output routines.

It is noted above that the generated software code may be directed to destination targets. The targets may include any one or more of display(s) 542, destination file(s) 544, destination database(s) 546, compiler(s) 547, remote destination(s) 548, interpreter(s) 549, and the like. It is contemplated that the sources and destination may or may not be the same. For example, it is within the scope of the invention to be able specify that a single file may serve as parameter file 514, template file 524, as well as the destination file 544, or one or more of these files may be separate from the others.

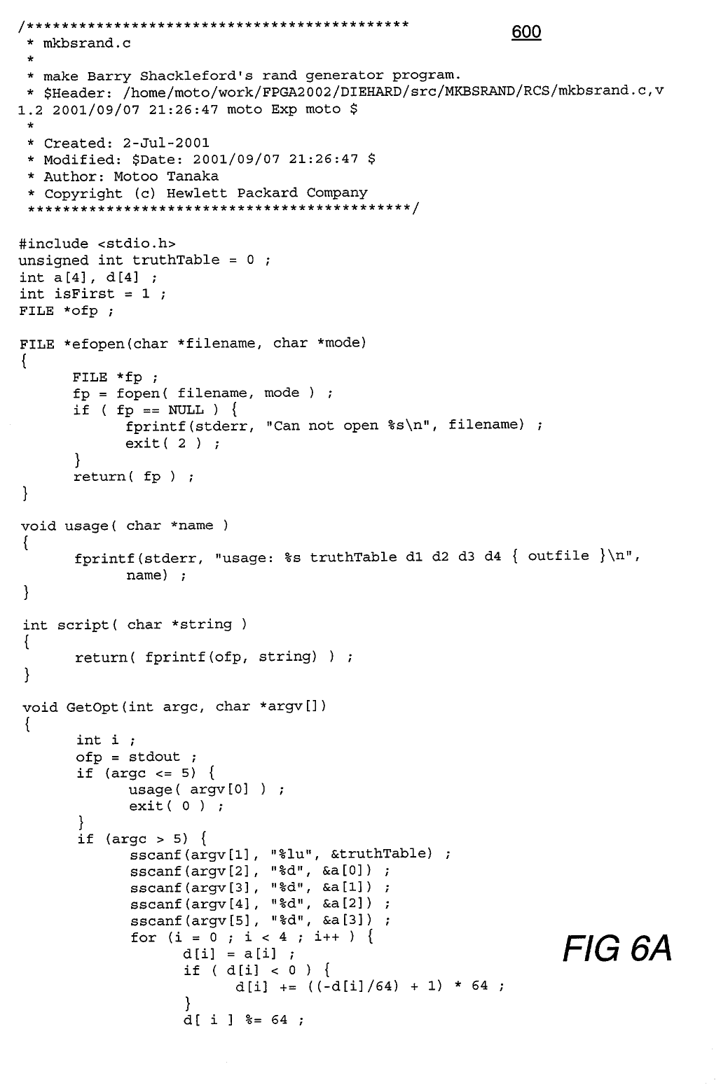

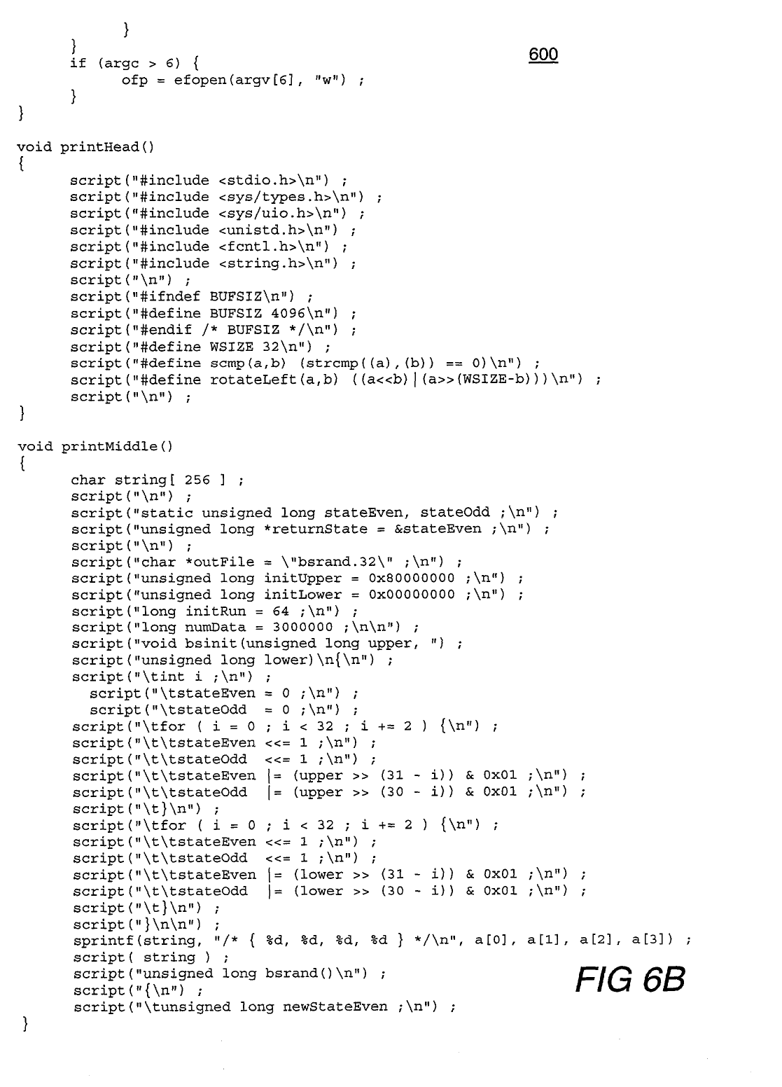

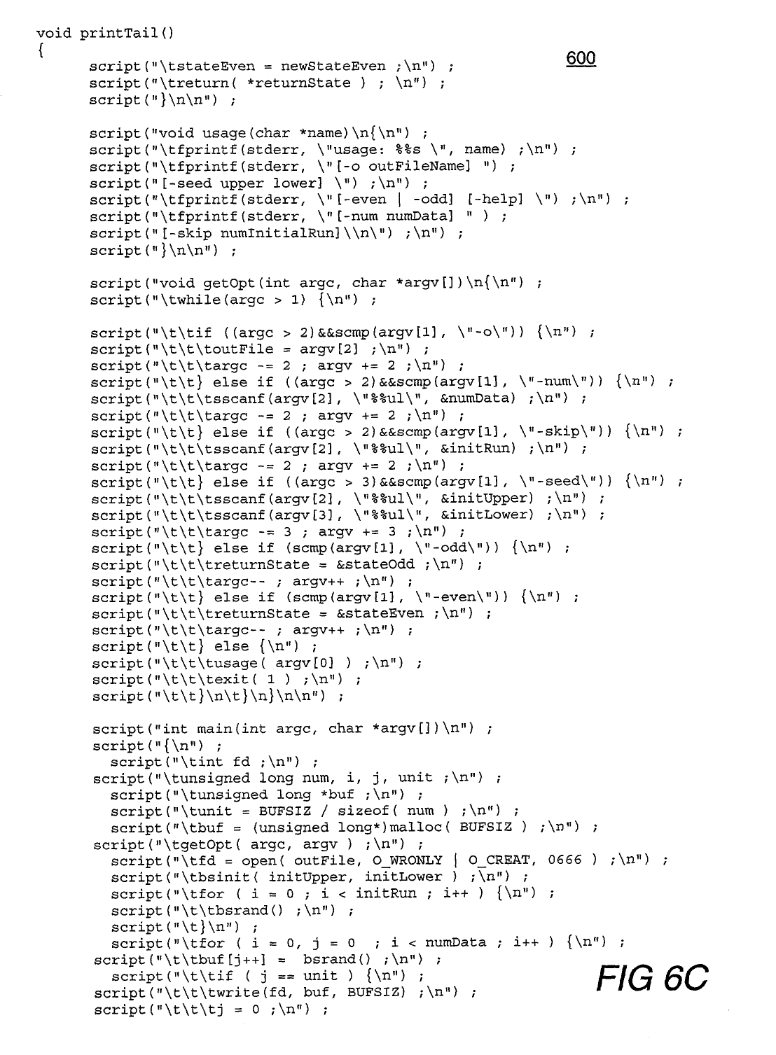

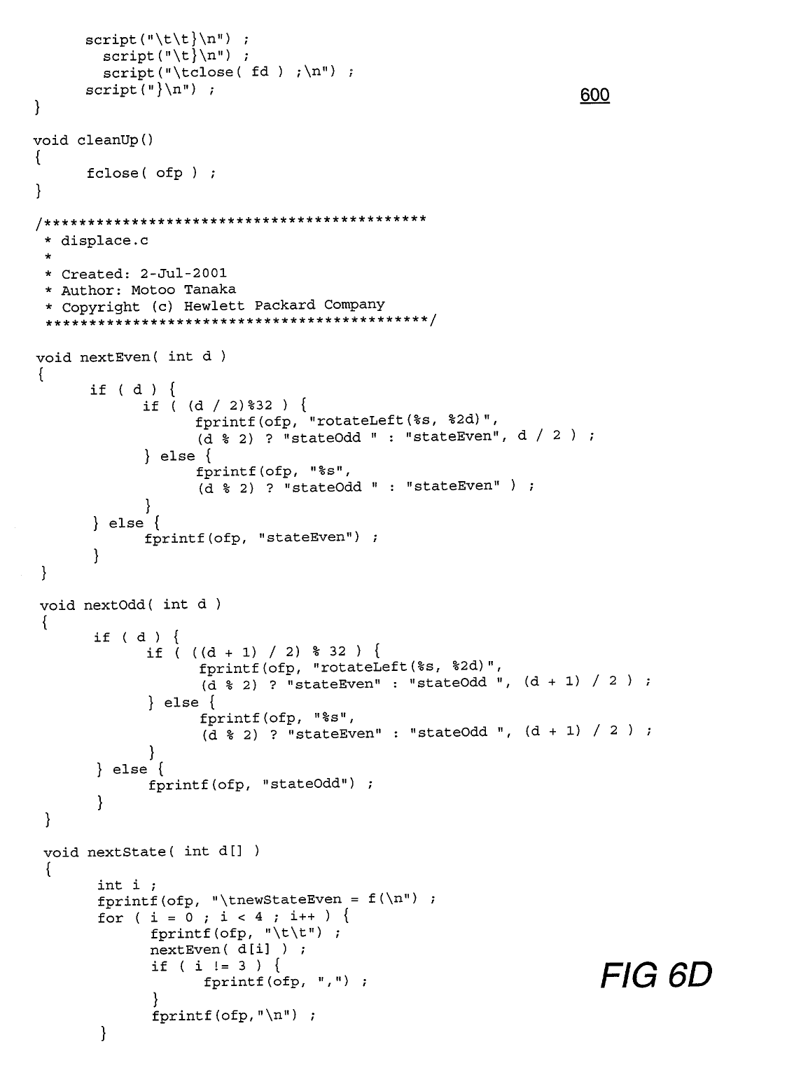

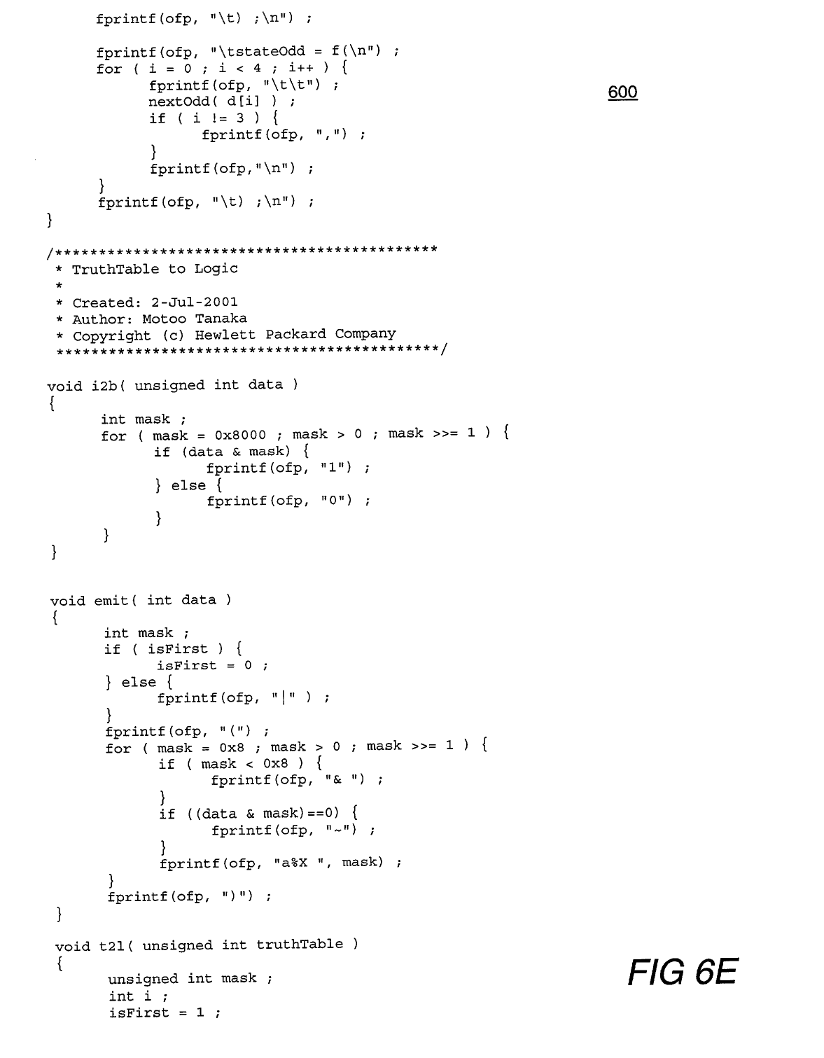

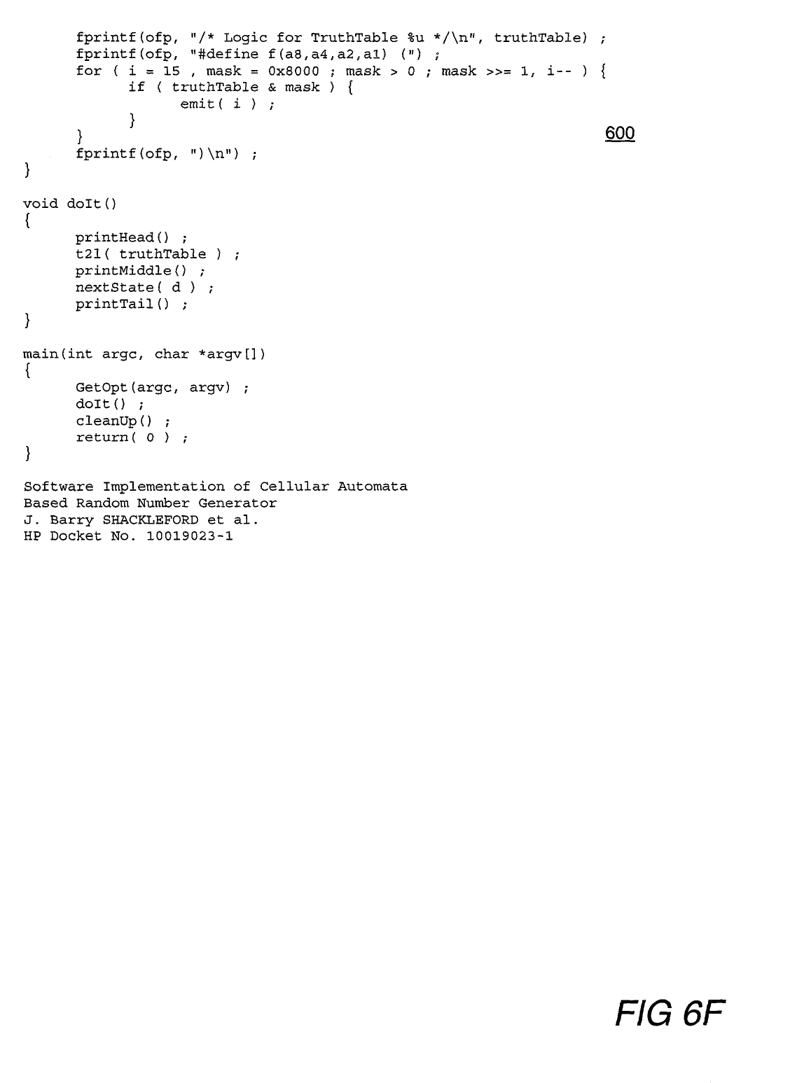

FIGS. 6A-6F collectively illustrate an exemplary software code 600 which generates software code to emulate CA-based RNGs. The code 600 is written in the C programming language. One or ordinary skill in the arts will recognize that the software code generator may be written in any number of programming languages. For simplicity, the code 600 includes only a built-in C language template. But as noted before, the code 600 may be modified to generate code in any of the desired programming languages.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method to emulate a cellular automata based random number generator (CA-based RNG) in software, comprising:
determining emulation parameters for said CA-based RNG;
initializing said software;
simulating behaviors of cells of said CA-based RNG in parallel; and
outputting result of said simulating step.

2. The method of claim 1, wherein said emulation parameters include at least one of a seed number of runs, and output designation.

3. The method of claim 1, wherein said step of determining emulation parameters includes retrieving said emulation parameters from at least one of a user, a file, a database, and a remote source.

4. The method of claim 1, wherein said step of determining emulation parameters includes providing default values for any emulation parameters not received from an external source.

5. The method of claim 1, wherein said simulating step includes simulating parallel site spacing.

6. The method of claim 1, wherein in said outputting step, destinations include at least one of a display, a file, a database, an application, and a remote destination.

7. A method to generate a software code which emulates a cellular automata based random number generator (CA-based RNG), said method comprising:
determining RNG parameters;
determining one or more programming language templates;
determining functional definition of said CA-based RNG;
determining initialization routines for said CA-based RNG;
determining simulation routines for said CA-based RNG;
determining simulation results destination routines for said CA-based RNG; and
outputting code for said CA-based RNG.

8. The method of claim 7, wherein said RNG parameters include at least one of an interconnection topology, a length of said desired CA-based RNG, a cellular automata truth table, one or more desired output programming language languages, one or more code output destinations, and site spacing specification.

9. The method of claim 7, wherein said step of determining RNG parameters includes retrieving said emulation parameters from at least one of one of a user, a file, a database, and a remote source.

10. The method of claim 7, wherein said step of RNG emulation parameters includes providing default values for any emulation parameters not received from an external source.

11. The method of claim 7, wherein said step of determining language templates includes retrieving said language templates from at least one of one of a user, a file, a database, and a remote source.

12. The method of claim 7, wherein said step of determining language template includes providing at least one default language template in response to no language being specified from an external source.

13. The method of claim 7, wherein said step of determining language template includes providing at least one built-in language template in response to no language being specified from an external source.

14. The method of claim 7, wherein said step of determining functional definition includes generating a Boolean sum-of-products equation for said CA-based RNG.

15. The method of claim 7, wherein said step of determining simulation routines includes generating code for one or both of operations for parallel simulation and operations for parallel site spacing.

16. The method of claim 7, wherein in said step of determining simulation results destination routines, generating code for destinations of simulation results to include at least one of a display, a file, a database, an application, and a remote destination.

17. The method of claim 7, wherein in said step of outputting code, destinations for said generated code include at least one of a display, a file, a database, a compiler, a remote destination, and an interpreter.

18. A system for generating a software code to emulate a cellular automata based random number generator (CA-based RNG), said system comprising:
a RNG-parameter-module determining RNG parameters;
a language-template-module determining language templates; and
and code-generating-module generating code for emulating said CA-based RNG.

19. The system of claim 18, wherein said RNG parameters include at least one of an interconnection topology, a length of said desired CA-based RNG, a cellular automata truth table, one or more desired output programming language languages, one or more output destinations, and site spacing specification.

20. The system of claim 18, wherein said RNG-parameter-module retrieves said emulation parameters from at least one of one of a user, a file, a database, and a remote source.

21. The system of claim 18, wherein said RNG-parameter-module provides default values for any emulation parameters not received from an external source.

22. The system of claim 18, wherein said language-template-module retrieves said language templates from at least one of one of a user, a file, a database, and a remote source.

23. The system of claim 18, wherein said language-template-module provides at least one default language template in response to no language being specified from an external source.

24. The system of claim 18, wherein said language-template-module provides at least one built-in language template in response to no language being specified from an external source.

25. The system of claim 24, wherein said code-generating-module includes:
a functional-definition-module generating a functional definition of said CA-based RNG;
an initialization-generation-module generating initialization routines;
a simulation-generation-module generating simulation routines; and
an output-generation-module generating simulation results output routines.

26. The system of claim 25, wherein said functional-definition-module (532) generates a Boolean sum-of-products equation for said CA-based RNG.

27. The system of claim 25, wherein said simulation-generation-module (536) generates code for one or both of operations for parallel simulation and operations for parallel site spacing.

28. The system of claim 25, wherein in said output destinations generated by said output-generation-module include at least one of a display, a file, a database, an application, and a remote destination.

29. The system of claim 18, wherein in said code-generating-module outputs said generated routines to at least one of a display, a file, a database, a compiler, a remote destination, and an interpreter.
